(19) United States
(12) Patent Application Publication
(10) Pub. No.: US 2025/0343858 A1
(43) Pub. Date: Nov. 6, 2025

(54) METHODS AND SYSTEMS FOR SHARING EMERGENCY CALL DATA

(71) Applicant: RapidSOS, Inc., New York, NY (US)

(72) Inventors: John Robert Katt, Bronx, NY (US); Matthew Keith MacDonald, Halifax (CA); Gabriel Charles Mahoney, Brooklyn, NY (US); Lucas Richard Eager Leavitt, Forest Hills, NY (US); Jamison Peevyhouse, Martin, TN (US); Emily Ingram, New York, NY (US); Nicholas Edward Horelik, Poughkeepsie, NY (US); William Thomas LePoidevin, Mesquite, NV (US); Joseph T. Cygan, Barrington, IL (US)

(21) Appl. No.: 19/187,782

(22) Filed: Apr. 23, 2025

Related U.S. Application Data
(60) Provisional application No. 63/642,919, filed on May 6, 2024.

(51) Int. Cl. H04M 3/51

(52) U.S. Cl. CPC H04M 3/5133; H04M 3/5116; H04M 3/5191

(57) ABSTRACT

Disclosed herein is an emergency response data platform (ERDP) that facilitates data exchange between various data sources and various data recipients. The ERDP may establish communication links with each of the various data sources and recipients and leverage these communication links to function as emergency data exchange between the data sources and/or recipients, for example, between different Public Safety Answering Points.

### CROSS-REFERENCE TO RELATED APPLICATION(S)

This application claims the benefit of U.S. Provisional Application No. 63/642,919 filed May 6, 2024, which is incorporated herein by reference in its entirety.

### BACKGROUND

A person in an emergency situation may request help using a mobile communication device such as a cell phone to dial a designated emergency number like 9-1-1 or a direct access phone number for the local emergency service provider (e.g. an emergency dispatch center). Traditionally, this call is assigned to one or more first responders by the emergency service provider, and the caller's estimated location (generally either the location of a nearby cell tower or a triangulation from the location of three or more nearby cell towers) is provided to the emergency service provider by the caller's wireless carrier (e.g., AT&T). Alternatively, the caller may provide their location to the emergency service provider by verbally speaking their location over the phone. Unfortunately, many emergency callers are unaware of their precise location or otherwise unable to verbalize it.

However, modern technologies have enabled the development and implementation of previously unimaginable or unachievable emergency services. For example, modern communication devices are capable of generating highly accurate, real-time locations (e.g., device-based hybrid locations) during emergency situations (e.g., in response to an emergency number being dialed) and transmitting the locations to emergency management systems and emergency service providers. Emergency service providers can then use these accurate locations to more quickly locate and dispatch emergency assistance to emergency callers. In another example, devices such as surveillance cameras can capture images, videos, or audio that can be shared in real-time with emergency management systems and emergency service providers to provide emergency service providers with situational awareness that they did not have access to in the past.

Likewise, many emergency service providers have upgraded various components of their systems to internet-enabled or cloud-based technologies that allow for easier integration with next generation emergency response technologies (e.g., Next Generation 911 technologies, or “NG911”). For example, through a public-private partnership, the United States recently deployed a nationwide wireless broadband communication system dedicated specifically to emergency service providers (i.e., FirstNet). Or for example, there are now cloud-based computer aided dispatch (CAD) systems that can be more agile and interoperable than the desktop applications that came before them. However, the adoption rates of these next generation emergency response technologies vary from emergency service provider to emergency service provider, due to differences in need, funding, jurisdiction, and system architecture.

### SUMMARY

Disclosed herein, in some aspects, is a method for providing emergency data to an emergency service provider (ESP) by an emergency response data platform (ERDP), the method comprising: providing, by a web server, an instance of an emergency response application to a web browser executed on an ESP computing device; receiving, by the instance of the emergency response application, emergency call data sent to the ESP computing device over a network operatively coupled to the ESP computing device; converting the emergency call data from a first format to a second format comprising a plurality of data fields; displaying at least a portion of the emergency call data in the second format within a graphical user interface (GUI) of the instance of the emergency response application. In some embodiments, further comprising providing, by the web server, a second instance of the emergency response application to a second web browser executing on a second ESP computing device and displaying at least a portion of the emergency call data in the second format within a GUI of the second instance of the emergency response application. In some embodiments, receiving, by the instance of the emergency response application, emergency call data sent to the ESP computing device over a network operatively coupled to the ESP computing device comprises: receiving the emergency call data sent to the ESP computing device over a message bus. In some embodiments, further comprising: receiving the emergency call data by a second instance of the emergency response application. In some embodiments, converting the emergency call data from a first format to a second format comprises: converting the emergency call data into an emergency incident data object (EIDO) where the second data format is an EIDO standard format. In some embodiments, displaying at least a portion of the emergency call data in the second format comprises: displaying a list of incidents and an interactive map. In some embodiments, further comprising: displaying at least one phone number and at least one location associated with the at least one phone number, wherein the at least one phone number is displayed as an incident within the list of incidents and the at least one location is displayed as an incident location within the interactive map. In some embodiments, receiving by the instance of the emergency response application, emergency call data sent to the ESP computing device over a network comprises: receiving the emergency call data by intercepting an automatic location information (ALI) feed broadcast to the ESP computing device over the network. Disclosed herein, in some aspects, is system configured to provide an emergency response data platform, the system comprising at least one processor configured to carry out the method of any of the preceding claims.

Disclosed herein, in some aspects, is an apparatus for emergency data to an emergency service provider (ESP) by an emergency response data platform (ERDP) at a web server comprising: a serial to packet data converter; a processor operatively coupled to the serial to packet data converter, the processor operative to: receive a stream of serial data comprising emergency call data transmitted to the ESP; convert the stream of serial emergency call data into packetized data having a data format comprising a plurality of data fields; and transmit the formatted data to an instance of an emergency response application executed on an ESP computing device. In some embodiments, the processor is further operative to receive a software update from a web server hosting the emergency response application. In some embodiments, the processor is further operative to receive the software update remotely after the apparatus is installed on premise at an ESP site. In some embodiments, the processor is further operative to: transmit a copy of the packetized data to the web server. In some embodiments, the serial to packet data converter is operative to: connect via a serial port to an automatic location information (ALI) controller at the ESP to receive the emergency call data from an automatic location information (ALI) database. In some embodiments, the processor is further operative to: format the emergency data into the data format comprising a plurality of data fields where the data format is an emergency incident data object (EIDO) standard format. In some embodiments, the instance of the emergency response application is operative to: display a graphical user interface (GUI) comprising a list of incidents and an interactive map. In some embodiments, the instance of the emergency response application is further operative to: display the emergency data within the GUI comprising at least one phone number and at least one location associated with the at least one phone number, with the at least one phone number displayed as an incident within the list of incidents and with the at least one location displayed as an incident location within the interactive map. In some embodiments, the instance of the emergency response application is provided to the ESP computing device by a web server. In some embodiments, further comprising: a radio transceiver, operatively coupled to the processor and to the serial to packet converter, the radio transceiver operative to send and receive emergency call data over a radio communication link.

Disclosed herein, in some aspects, is a method for providing emergency data to an emergency service provider (ESP) by an emergency response data platform (ERDP), the method comprising: providing, by a web server of the ERDP, a clearinghouse of the emergency data, wherein the clearinghouse comprises one or more databases hosted on a web server; receiving, by the web server of the ERDP, an emergency data request comprising a user identifier and an ALI data from a software application executed on an ESP computing device regarding an emergency; querying the clearinghouse for emergency data using the user identifier to find information about the emergency; and transmitting, by the ERDP, a response to the emergency data request based on one or more results from the clearinghouse for display of emergency data within a graphical user interface (GUI) at the ESP computing device. In some embodiments, further comprising: receiving, by the web server of the ERDP, an emergency alert comprising the user identifier and a device-based hybrid location generated by an electronic device associated with the user identifier; transmitting the response comprising the location generated by the electronic device, in response to receiving the emergency data request, the device-based hybrid location. In some embodiments, further comprising: displaying the device-based hybrid location within a GUI of the software application that is unrelated to the ERDP emergency response application. In some embodiments, displaying the device-based hybrid location within a GUI of the software application comprises: displaying the device-based hybrid location within a computer aided dispatch (CAD) system GUI where the software application is a CAD system software. In some embodiments, further comprising: providing a graphical user interface (GUI) by an instance of the emergency response application, the GUI comprising a list of incidents and an interactive map. In some embodiments, transmitting a response to the emergency data request, comprises: transmitting at least one phone number and at least one location associated with the at least one phone number; and displaying the at least one phone number as an incident within the list of incidents within the GUI; and displaying the at least one location as an incident location within an interactive map of the GUI. In some embodiments, further comprising: formatting the user identifier and the location into an emergency incident data object (EIDO) standard format. In some embodiments, further comprising: converting the emergency data request from serial data to packetized data. In some embodiments, further comprising: formatting the packetized data into an emergency incident data object (EIDO) standard format. In some embodiments, further comprising: receiving emergency call data related to the emergency data request from an automatic location information (ALI) database. In some embodiments, further comprising: displaying ALI location and device-based hybrid location within the GUI of the ESP computing device. Disclosed herein, in some aspects, is system configured to provide an emergency response data platform, the system comprising at least one processor configured to carry out the method of any of the preceding claims.

Disclosed herein, in some aspects, is a method for providing emergency data redundancy in an emergency service provider network comprising: receiving emergency data at a first device over a first data feed from a first controller; receiving the emergency data at a second device over a second data feed from the first controller and operating the second device in a hot standby mode; sending the emergency data from the first device to a web server; determining failure of the first device has occurred; and sending the emergency data from the second device in response to determining that failure of the first device has occurred. In some embodiments, receiving emergency data at a first device and receiving the emergency data at a second device, comprises: receiving the emergency data at the first device over the first data feed from a first automatic location information (ALI) controller where the first data feed is a first serial data feed; and receiving the emergency data at a second device over the second data feed from the first ALI controller, where the second data feed is a second serial data feed. In some embodiments, determining failure of the first device has occurred comprises: detecting a device failure indication on a communication link between the first device and the second device. In some embodiments, further comprising: converting the emergency data at the first device from serial emergency data to packetized emergency data; and converting the emergency data at the second device from serial emergency data to packetized emergency data. Disclosed herein, in some aspects, is system configured to provide an emergency response data platform, the system comprising at least one processor configured to carry out the method of any of the preceding claims.

Disclosed herein, in some aspects, is a method for providing emergency data redundancy in an emergency service provider network comprising: receiving emergency data at a first device over a first data feed from a first controller, and from a second data feed from a second controller; receiving the emergency data at a second device over a third data feed from the first controller and over a fourth data feed from the second controller; converting, by the first device, serial emergency data from the first data feed and from the second data feed to packetized emergency data; discarding duplicated packets from the first data feed and from the second data feed at the first device; converting, by the second device, serial emergency data from the third data feed and from the fourth data feed to packetized emergency data; discarding duplicated packets from the third data feed and from the fourth data feed at the second device; sending packetized emergency data from the first device and from the second device to a web server; discarding, by the web server, duplicate packets in the packetized emergency data from the first device and the second device; and sending packetized emergency data from the web server to at least one instance of an emergency response application provided by the web server to at least one emergency service provider computing device. Disclosed herein, in some aspects, is system configured to provide an emergency response data platform, the system comprising at least one processor configured to carry out the method of any of the preceding claims.

Disclosed herein, in some aspects, is an emergency services provider network comprising: a first serial to packet converter operatively coupled to an automatic location information (ALI) controller via a first serial data connection, the first serial to packet converter operative to convert serial emergency data to packetized emergency data and send the packetized emergency data to a web server over a network connection; and a second serial to packet converter operatively coupled to the ALI controller via a second serial data connection and to the first serial to packet converter via a communication link, the second serial to packet converter operative to convert serial emergency data to packetized emergency data, further operative to detect a failure indication signal over the communication link, and to send the packetized emergency data to the web server over the network connection in response to detecting the failure indication.

Disclosed herein, in some aspects, is an emergency services provider network comprising: a first serial to packet converter operatively coupled to a first ALI controller via a first serial data connection and to a second ALI controller via a second serial data connection; and a second serial to packet converter operatively coupled to the first ALI controller via a third serial data connection and to the second ALI controller via a second serial data connection. In some embodiments, the first serial to packet converter and the second serial to packet converter are further each operatively coupled to a web server via a network connection. In some embodiments, the first ALI controller is located at a first ESP agency and the second ALI controller is located at a second ESP agency, wherein the first ESP agency and the second ESP agency are in neighboring jurisdictions.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 depicts a diagram of an emergency response data platform.

FIG. 2 illustrates a graphical user interface (GUI) provided by an emergency response application, in accordance with some embodiments.

FIG. 3A and FIG. 3B depict systems and processes for receiving and transmitting emergency data by an emergency response data platform.

FIG. 4 depicts a diagram of an emergency service provider (ESP) in communication with an emergency response data platform (ERDP).

FIG. 5 depicts a diagram of an ESP in communication with an ERDP; and

FIG. 6 illustrates a GUI provided by an emergency response application in accordance with some embodiments.

FIG. 7 is a diagram of an apparatus in accordance with an embodiment.

FIG. 8 is a diagram of a network configuration for emergency data redundancy in accordance with various embodiments.

FIG. 9 is a flowchart of a method of operation for emergency data redundancy in accordance with some embodiments.

FIG. 10 is a flowchart of a method of operation for emergency data redundancy in accordance with some embodiments.

FIG. 11 is a flowchart of a method of operation in accordance with various embodiments.

FIG. 12 is a flowchart of a method of operation in accordance with various embodiments.

### DETAILED DESCRIPTION

Disclosed herein are systems, devices, media, and methods for providing enhanced emergency communications and functions. The disclosed systems, devices, media and methods, among other things, take advantage of technological advancements that have allowed for mobile communication devices to generate accurate locations by incorporating multiple technologies embedded in the devices, such as GPS, Wi-Fi, and Bluetooth to create device-based hybrid locations. Device-based hybrid locations are locations calculated on an electronic or communication device, as opposed to locations calculated using a network (e.g., a carrier network). Device-based hybrid locations can be generated using GPS, network-based technologies, Wi-Fi access points, Bluetooth beacons, barometric pressure sensors, dead reckoning using accelerometers and gyrometers, and a variety of crowdsourced and proprietary databases that device operating systems providers are running to enhance location technology. These device-based hybrid locations can be quickly generated during emergency calls. Furthermore, mobile communication devices (e.g., mobile phones, wearables, IoT devices, smart home devices, vehicle computers, etc.) are often capable of generating or storing additional information that may be useful in responding to emergency situations, such as health data or medical histories. For example, during an emergency, a modern mobile communication device may have access to an implicated person's blood type, preexisting medical conditions, or even the implicated person's current heartrate. In some embodiments, the mobile communication device has access to data from sensors (e.g., health or environmental sensors). For example, a video feed of the emergency via a connected surveillance camera can provide valuable situational awareness regarding the emergency.

In one aspect, disclosed herein is an emergency response data platform (ERDP) capable of receiving emergency data (e.g., device-based hybrid locations and additional emergency information, such as health data, medical emergencies, and multimedia) from smart devices and systems (e.g., mobile phones and IoT devices) and transmitting the emergency data to emergency service providers (ESPs) to assist the ESPs in responding to emergencies. However, while device-based hybrid locations are generally more accurate and more quickly generated than the locations estimated by wireless carriers (as mentioned above), device-based hybrid locations are generally only available for emergency calls made by mobile phones. Thus, because ESPs receive emergency calls from both mobile phone and landline phones, if the ERDP were to only provide device-based hybrid locations to an ESP, the ERDP would not be providing locations to the ESP for all of the emergency calls received by the ESP. There is therefore a desire for the ERDP to source and ingest locations associated with landline phones that make emergency calls to ESPs, so that the ERDP can provide locations to an ESP for all of the emergency calls that the ESP receives. In another aspect, then, disclosed herein is an ERDP capable of receiving emergency data from smart devices and systems and emergency call data (e.g., data associated with emergency calls made to ESPs) and transmitting both the emergency data and the emergency call data to the ESPs to assist the ESPs in responding to emergencies.

### Emergency Response Data Platform

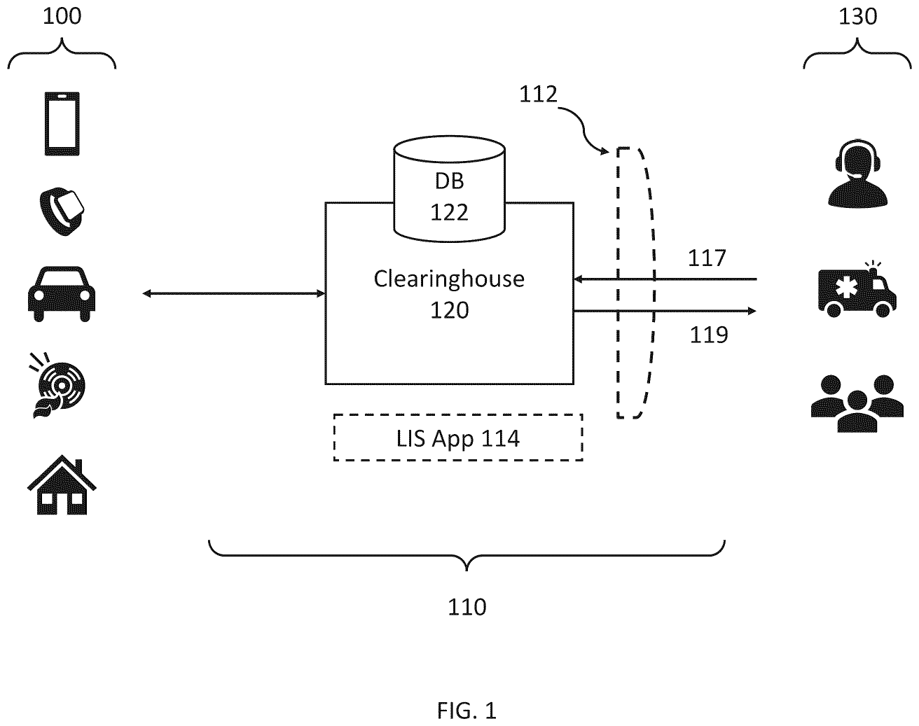

In various embodiments, disclosed herein are devices, systems, and methods for managing emergency data and emergency communications for more effective and efficient emergency response. FIG. 1 depicts a diagram of an emergency response data platform in accordance with one embodiment of the present disclosure. In a simple example, in some embodiments, an emergency data source 100 transmits emergency to an emergency response data platform (ERDP) 110 before, during, or after an emergency, and the emergency response data platform shares the emergency data with an emergency service provider (ESP) 130. The ESP 130 can then use the emergency data to more efficiently and effectively respond to corresponding emergencies. In some embodiments, the emergency data source 100 is a third-party server system (hereinafter, “third-party server”). For example, in some embodiments, the emergency data source 100 is a third-party server (e.g., a backend server system) of a technology company that produces software for electronic devices, such as Apple or Google. In some embodiments, the emergency data source 100 is an electronic device. For example, the emergency data source 100 may be a communication device (e.g., a walkie talkie or two-way radio, a mobile or cellular phone, a computer, a laptop, etc.), a wearable device (e.g., a smartwatch), or an Internet of Things (IoT) device such as a home assistant (e.g., an Amazon Echo) or a connected smoke detector (e.g., a Nest Protect smoke and carbon monoxide alarm). In some embodiments, an electronic device includes a display, a processor, a memory (e.g., an EPROM memory, a RAM, or a solid-state memory), a network component (e.g., an antenna and associated components, Wi-Fi adapters, Bluetooth adapters, etc.), a data storage, a user interface, an emergency alert program, one or more location components, and one or more sensors. In some embodiments, the processor is implemented as one or more microprocessors, microcomputers, microcontrollers, digital signal processors, central processing units, state machines, logic circuitries, and/or devices that manipulate signals based on operational instructions. Among other capabilities, the processor is configured to fetch and execute computer-readable instructions stored in the memory.

In some embodiments, the display is part of the user interface (e.g., a touchscreen is both a display and a user interface in that it provides an interface to receive user input or user interactions). In some embodiments, the user interface includes physical buttons such as an on/off button or volume buttons. In some embodiments, the display and/or the user interface comprises a touchscreen (e.g., a capacitive touchscreen), which is capable of displaying information and receiving user input. In some embodiments, the communication device includes various accessories that allow for additional functionality. In some embodiments, these accessories (not shown) include one or more of the following: a microphone, a camera, speaker, a fingerprint scanner, health or environmental sensors, a USB or micro-USB port, a headphone jack, a card reader, a SIM card slot, or any combination thereof. In some embodiments, the one or more sensors include, but are not limited to: a gyroscope, an accelerometer, a thermometer, a heart rate sensor, a barometer, or a hematology analyzer. In some embodiments, the data storage includes a location data cache and a user data cache. In some embodiments, the location data cache is configured to store locations generated by the one or more location components.

In some embodiments, the emergency alert program is a web application or mobile application. In some embodiments, the emergency alert program is configured to record user data, such as a name, address, or medical data of a user associated with the electronic device. In some embodiments, the emergency alert program is configured to detect when an emergency request is generated or sent by the electronic device (e.g., when a user uses the electronic device to make an emergency call). In some embodiments, in response to detecting an emergency request generated or sent by the electronic device, the emergency alert program is configured to deliver a notification to the ERDP 110. In some embodiments, the notification is an HTTP post containing information regarding the emergency request. In some embodiments, the notification includes a location (e.g., a device-based hybrid location) generated by or for the electronic device. In some embodiments, in response to detecting an emergency request generated or sent by the electronic device, the emergency alert program is configured to deliver user data to the ERDP 110.

In some embodiments, the emergency response data platform (ERDP) 110 includes an ERDP operating system, an ERDP CPU, an ERDP memory unit, an EMS communication element, and one or more software modules. In some embodiments, the ERDP CPU is implemented as one or more microprocessors, microcomputers, microcontrollers, digital signal processors, central processing units, state machines, logic circuitries, and/or devices that manipulate signals based on operational instructions. Among other capabilities, the ERDP CPU is configured to fetch and execute computer-readable instructions stored in the ERDP memory unit. The ERDP memory unit optionally includes any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The ERDP memory unit optionally includes modules, routines, programs, objects, components, data structures, etc., which perform particular tasks or implement particular abstract data types.

In some embodiments, the ERDP 110 includes one or more ERDP databases, one or more servers, and a clearinghouse 120. In some embodiments, the clearinghouse 120, as described in further detail below, is an input/output (I/O) interface configured to manage communications and data transfers to and from the ERDP 110 and external systems and devices. In some embodiments, the clearinghouse 120 includes a variety of software and hardware interfaces, for example, a web interface, a graphical user interface (GUI), and the like. The clearinghouse 120 optionally enables the ERDP 110 to communicate with other computing devices, such as web servers and external data servers. In some embodiments, the clearinghouse 120 facilitates multiple communications within a wide variety of networks and protocol types, including wired networks, for example, LAN, cable, etc., and wireless networks, such as WLAN, cellular, or satellite. In some embodiments, the clearinghouse 120 includes one or more ports for connecting a number of devices to one another or to another server. In some embodiments, the clearinghouse 120 includes one or more sub-clearinghouses, such as location clearinghouse and additional data clearinghouse, configured to manage the transfer of locations and additional data, respectively. In some embodiments, the ERDP 110 additionally includes a user information module that receives and stores user information (e.g., personal information, demographic information, medical information, location information, etc.) within the ERDP 110. In some embodiments, users can submit user information through a website, web application, or mobile application, such as during a registration process for an emergency response application. In some embodiments, when the ERDP 110 receives emergency data including user information, such as through an emergency alert received by the clearinghouse 120 (as described below), the ERDP 110 stores the user information in the user information module. In some embodiments, user information stored within the user information module is received by the ERDP 110 from a third-party server system, as described above. In some embodiments, user information stored within the user information module is associated with an identifier of a user or an electronic device associated with a user, such as a phone number or an email address. APIs may be used to query data from the clearinghouse. For example, LIS App for querying location information and ADR App for querying additional data about an emergency. A query from an ESP agency may be received via such API and the response will be returned in response to the query and may be displayed within the GUI at the ESP.

As mentioned above, in some embodiments, the emergency response data platform (ERDP) 110 shares emergency data with an emergency service provider (ESP) 130. In some embodiments, an ESP 130 (e.g., a public safety answering point (PSAP)) is a system that includes one or more of a display, a user interface, at least one central processing unit or processor, a network component, an audio system, (e.g., microphone, speaker and/or a call-taking headset), and an ESP application (e.g., a computer program) such as a computer aided dispatch (CAD) program or an emergency call taking program (also referred to as customer premise equipment or CPE). In some embodiments, the ESP application comprises a database of emergency responders, such as medical assets, police assets, fire response assets, rescue assets, safety assets, etc. In some embodiments, the ESP application is an emergency response application provided by the ERDP 110, as described below. In some embodiments, the ESP application is installed on a computing device at the ESP 130 and comprise one or more software modules, such as a call taking module, an ESP display module, a supplemental or updated information module, or a combination thereof. In some embodiments, the ESP application displays the information on a map (e.g., on the display). In some embodiments, the ESP application is accessible or executable on mobile devices associated with ESP 130, such as first responder devices. In some embodiments, the ESP application is an emergency response application provided by the ERDP 110, as described below.

### Emergency Clearinghouse

In some embodiments, as mentioned above with respect to FIG. 1, the emergency response data platform (ERDP) 110 includes a clearinghouse 120 (also referred to as an “Emergency Clearinghouse”) for receiving, storing, retrieving, and transmitting emergency data. In some embodiments, as depicted by FIG. 1, through the clearinghouse 120, the ERDP 110 can receive emergency data from an emergency data source 100 (as described above) and transmit the emergency data to an emergency data recipient, such as an emergency service provider (ESP) 130 (as described above). In this way, the ERDP 110 acts as a data pipeline between emergency data sources 100 and ESPs 130. The emergency data that passes through the clearinghouse 120 may include (but is not limited to) location data (e.g., fixed addresses or device-based hybrid locations generated in real time) and additional data (e.g., medical history, personal information, or contact information, etc.). In some embodiments, through the clearinghouse 120, the ERDP 110 transmits emergency data to ESPs 130 to aid the ESPs 130 in responding to emergencies. For example, location data may allow emergency responders to arrive at the scene of an emergency faster, and additional data may allow emergency responders to be better prepared for the emergencies that they face.

The clearinghouse 120 may receive emergency data in various ways. For example, in some embodiments, an emergency data source 100 can unilaterally transmit emergency data to the clearinghouse 120. For example, in one embodiment, an emergency alert is triggered by an electronic device manually (e.g., in response to the selection of a soft or hard emergency button) or automatically based on sensor data received by the electronic device (e.g., smoke alarms). The electronic device can then transmit the emergency alert and any associated data to the ERDP 110, such as to an endpoint provided by the clearinghouse 120. Or, for example, in one embodiment, after an emergency alert is received by the ERDP 110 from a first emergency data source, the ERDP 110 can query a second emergency data source for emergency data (e.g., emergency data associated with the emergency alert received from the first emergency data source). For example, the emergency alert received from the first emergency data source may include a user identifier (e.g., a telephone number or an email address) for an owner or user of the first emergency data source. The ERDP 110 can then query the second emergency data source with the user identifier to retrieve additional emergency data associated with the owner or user of the first emergency data source. In some embodiments, emergency data received by the ERDP 110 is received in a format that is compatible with industry standards for storing and sharing emergency data. In some embodiments, the ERDP 110 formats emergency data that it receives into a format that is compatible with industry standards. For example, in some embodiments, the emergency data is formatted to be compatible with National Emergency Number Association (NENA) standards. In some embodiments, emergency data is formatted by the ERDP 110 to be compliant with the Presence Information Data Format Location Object (PIDF-LO) standard. In some embodiments, emergency data (or emergency call data, as described below) is formatted by the ERDP to be compliant with the Emergency Incident Data Object (EIDO) standard. In some embodiments, emergency data received by the ERDP 110 is stored within one or more databases 122. In some embodiments, emergency data received by the ERDP 110 is associated with one or more identifiers, such as a device or user identifier.

The clearinghouse 120 may share emergency data in various ways. For example, in some embodiments, an emergency data recipient, such as an ESP 130, can query the ERDP 110 for emergency data. For example, in some embodiments, an ESP 130 can query the ERDP 110 with an emergency data request including a user identifier (e.g., a telephone number or an email address) to receive emergency data gathered or received by the ERDP 110 associated with the user identifier. Or for example, in some embodiments, an ESP 130 can query the ERDP 110 with a geospatial area to receive emergency data gathered or received by the ERDP 110 associated with the geospatial area. Alternatively, in some embodiments, the ERDP 110 can autonomously transmit emergency data to an emergency data recipient without first receiving a query from the emergency data recipient (also referred to as “pushing” emergency data, as opposed to emergency data being “pulled” with a query). In some embodiments, the ERDP 110 pushes emergency data to an emergency data recipient using an emergency data subscription system. Using the emergency data subscription system, an emergency data recipient can subscribe to the clearinghouse 120 for a particular device identifier, user identifier, ESP account, or geospatial area. After subscribing to a subscription, the emergency data recipient may automatically receive updates regarding the subscription without first sending a query for emergency data. For example, if an ESP 130 subscribes to a phone number, whenever the ERDP 110 receives updated emergency data associated with the phone number, the clearinghouse 120 can instantly and automatically transmit the updated emergency data associated with the phone number to the ESP 130.

### Emergency Data Geofencing

In some embodiments, a geofence system 112 is applied to egress from the clearinghouse 120 or the ERDP 110 to protect sensitive emergency data from being shared with unintended recipients. For example, the geofence system 112 may check the authorization of a requesting agency to see if the emergency location is within the jurisdictional area of the requesting agency. As depicted in FIG. 1, in some embodiments, when emergency data (e.g., an emergency location or additional data) is received by the ERDP 110 from an emergency data source 100 (ingress data), the emergency data is first filtered via the geofence system 112 before being ingested by the clearinghouse 120 (not shown). Similarly, in some embodiments, when a query 117 for emergency data is received by the ERDP 110 from an emergency data recipient (e.g., an ESP 130), the query is processed by the geofence system 112 before response 119 emergency data is transmitted to the emergency data recipient. In some embodiments, the query 117 comprising a user identifier (e.g., a phone number) is sent to a location app (e.g., LIS App 114), where the response 119 comprising a location (e.g., a lat/lon, an address) of an emergency. Although not shown, queries may be sent to an additional data app (e.g., ADR app) for additional information (e.g., user data, medical data, sensor data) about an emergency.

Generally, a geofence is a virtual perimeter that represents a real-world geographic area. A geofence can be dynamically generated—as in a radius around a point location—or a geofence can be a predefined set of boundaries (such as school zones or neighborhood boundaries). For emergency response, an emergency service provider (public or private entities) may be given jurisdictional authority to a certain geographical region or jurisdiction (also referred to as “authoritative regions”). In the context of emergency services, one or more geofences may correspond to the authoritative region of an ESP. In many cases, the ESP is a public entity such as a public safety answering point (PSAP) or a public safety service (PSS; e.g., a police department, a fire department, a federal disaster management agency, national highway police, etc.), which have jurisdiction over a designated area (sometimes, overlapping areas). Geofences are used to define the jurisdictional authority by various methods and in various Geographic Information System (GIS) formats. In some embodiments, geofences only represent authoritative regions if the geofence has been assigned or verified by a local, state, or federal government. In some embodiments, geofences represent assigned jurisdictions that are not necessarily authoritative regions. For example, in some embodiments, a geofence is unilaterally created by its associated ESP without verification or assignment by a local, state, or federal government.

In some embodiments, the ERDP 110 maintains a geofence database including one or more geofences associated with each ESP 130 that is or has ever been communicatively coupled to the ERDP 110. In some embodiments, a geofence associated with an ESP 130 may be submitted to the ERDP 110 by an administrator of the ESP 130, such as through an emergency response application (as described below) or via email. In some embodiments, when emergency data is received by the ERDP 110 the ERDP 110 identifies a location associated with the emergency data (e.g., an emergency location included in an emergency alert) and determines if the location is within the combined authoritative jurisdiction (i.e., within any one of the geofences stored in the geofence database). In some embodiments, if the location is not within the combined authoritative jurisdiction, the ERDP 110 rejects or drops the emergency data (also referred to as “ingress filtering”). In some embodiments, when the ERDP 110 receives a query for emergency data from an ESP 130, the ERDP 110 identifies a geofence associated with the ESP 130 and returns only emergency data associated with locations that are within the geofence associated with the ESP 130 (also referred to as “egress filtering). In some embodiments, geofences are used in routing emergency data that is pushed to an emergency data recipient. In some embodiments, example, as mentioned above, an emergency data recipient may subscribe to a geofence. Then, when the ERDP 110 receives emergency data associated with a location that is within the geofence to which the emergency data recipient has subscribed, the ERDP 110 can instantly and automatically push the emergency data to the emergency data recipient.

### Emergency Response Application

As mentioned above, in some embodiments, data and information is shared between the emergency response data platform (ERDP) and an emergency service provider (ESP) through an emergency response application. In some embodiments, as described in further detail below, the emergency response application may additionally be provided to an ESP to: a) facilitate communications between the ESP and an emergency caller (e.g., a person requesting emergency assistance) or b) facilitate communications between the ESP and one or more other ESPs. In some embodiments, the emergency response application is a software application either installed on a computing device at the ESP or accessed via the internet through a web browser on the computing device (e.g., the emergency response application is hosted on a cloud computing system by the ERDP). In some embodiments, the emergency response application functions to both facilitate a two-way communication link between the ERDP and the ESP and visualize data (e.g., emergency data) received by the ESP from the ERDP. The emergency response application optionally includes various components, such as a frontend application (hereinafter “graphical user interface” or “GUI”), a backend application, an authorization module, and a user database. In some embodiments, the emergency response application additionally or alternatively includes a credential management system or a geofence system (which may include or be otherwise communicatively coupled to a credentials database or a geofence database). In some embodiments, the credential management system and the geofence system are external to the emergency response application and communicatively coupled to the emergency response application (e.g., the credential management system or geofence system can be housed or hosted on a cloud computing system by the ERDP). Any or all of the components of the emergency response application may be hosted on a cloud computing system by the ERDP, a computing device at an ESP, or some combination thereof.

In some embodiments, the emergency response application is a webpage or web application that can be accessed through an internet or web browser. In such embodiments, the emergency response application can be quickly and easily integrated into the systems used by emergency service providers (ESPs), such as public safety answering points (PSAPs), because accessing and using emergency response application requires no additional software or hardware outside of standard computing devices and networks. As previously discussed, one of the greatest hinderances that PSAPs face in providing emergency assistance to people experiencing emergency situations is in acquiring accurate locations of the emergencies and the people involved, because PSAPs are currently typically limited to verbally asking for and verbally receiving locations from callers. In some embodiments, the clearinghouse is capable of receiving accurate locations (as well as additional emergency data, as described above) from electronic devices such as smartphones and delivering the accurate locations to the appropriate PSAPs during emergency situations. Therefore, it is advantageous to provide the emergency response application to PSAPs in the form of a webpage accessible through a standard web browser, in order to provide the potentially life-saving information stored within the clearinghouse to those capable of providing emergency assistance as quickly and easily as possible. However, in some embodiments, the emergency response application is a software application installed on a computing device at an ESP. The emergency response application may be provided by the ERDP or by a third-party.

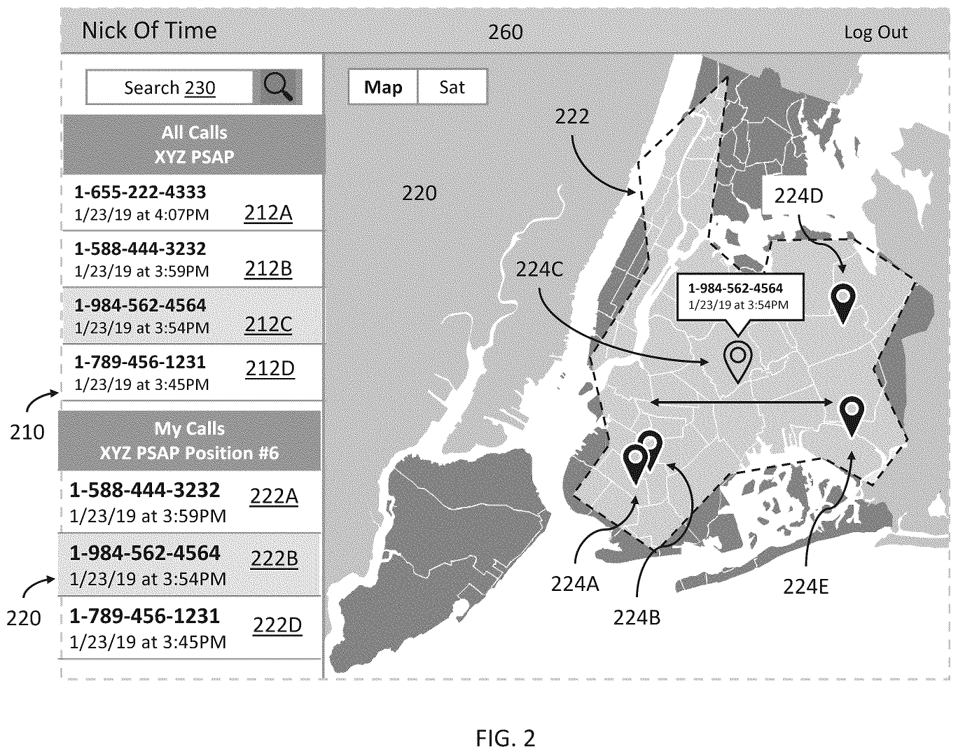

FIG. 2 illustrates a graphical user interface (GUI) provided by an emergency response application 260 in accordance with some embodiments. In some embodiments, the GUI provides interactive elements that allow a user at an ESP to receive data from the ERDP, visualize data received from the ERDP, and transmit data to the ERDP. For example, in some embodiments, the GUI includes an entry field 230 through which a user can submit a device identifier, such as by typing or pasting the device identifier into the entry field 230. In some embodiments, after submitting a device identifier through the entry field 230, the user can prompt the emergency response application to generate and send an emergency data request by selecting a search button. The emergency response application 260 then generates an emergency data request including the device identifier and any other necessary information (e.g., a temporary access token) and transmits the emergency data request to the ERDP. The ERDP can then return any available emergency data associated with the device identifier to the emergency response application 260, as described above and below. In another example, in some embodiments, the emergency response application 260 can automatically receive emergency data from the ERDP for emergencies relevant to an ESP (e.g., emergencies located within the jurisdiction of the ESP) without requiring a user to generate an emergency data request, as described above and below. After receiving emergency data from the ERDP, the emergency response application 260 can then visualize the emergency data within the GUI of the emergency response application 260. For example, in some embodiments, the emergency response application 260 includes a list of incidents 210 and an interactive map 220, as illustrated by FIG. 2. As shown, an example display at a PSAP is depicted with two queues-one queue may show calls coming into the PSAP (“All Calls”) and another queue specific to the call taker/dispatcher position “My Calls.” In some embodiments, when the emergency response application 260 receives a location (e.g., an emergency location) and a device identifier associated with an emergency occurring within the jurisdiction 222 of the receiving ESP, the emergency response application 260 displays the location associated with the emergency within the interactive map 220 as a location marker 224 (also referred to as an “incident location”) and displays the device identifier associated with the emergency within the list of incidents 210 as an incident 212.

In addition to emergency locations, the emergency response application 260 can receive and visualize numerous types of emergency data from the ERDP. For example, the emergency response application 260 can receive additional data regarding an emergency, such as demographic or medical data associated with a person involved in the emergency (e.g., an emergency caller). In another example, the emergency response application 260 can receive data from sensors associated with the emergency, such as heartrate data collected by a sensor on an emergency caller's smartwatch. Or, for example, the emergency response application 260 can receive data regarding emergency response assets available for an emergency, as described below. In some embodiments, the emergency response application receives and visualizes messages received from emergency callers or other ESPs, as described below. The emergency response application 260 can visualize any emergency data received from the ERDP within the GUI of the emergency response application.

### Emergency Data Transmission

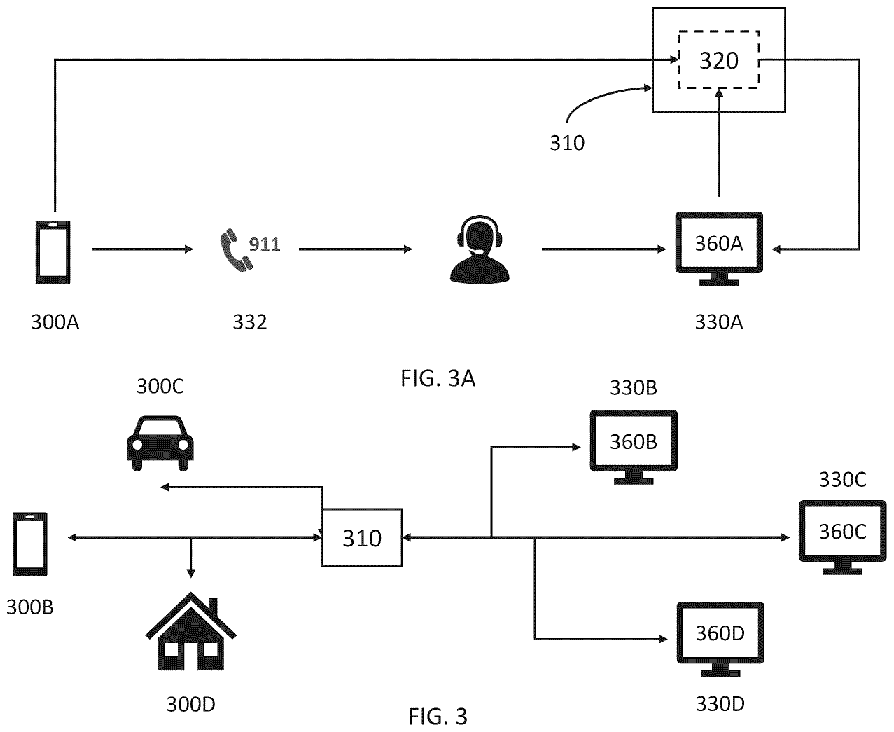

FIGS. 3A and 3B depict systems and processes for receiving and transmitting emergency data by an emergency response data platform in accordance with some embodiments of the present disclosure. As described above, in some embodiments, an emergency response data platform (ERDP) maintains a clearinghouse that obtains and shares emergency data to aid emergency service providers (ESPs) in responding to emergencies via queries and responses as shown in FIG. 1. In another example, as depicted in FIG. 3A, during an emergency, an ESP 330A can send a query for emergency data (also referred to as an “emergency data request”) to the ERDP 310 (e.g., through an emergency response application 360A, as described above) for a particular emergency, and, in response, the ERDP 310 can send any available emergency data associated with the emergency back to the ESP 330A (such as through emergency response application 360A). In some embodiments, as described above, the emergency response application 360A includes an identifier associated with an emergency alert in the emergency data request. The ERDP 310 can then use the identifier associated with the emergency alert to retrieve emergency data associated with the emergency alert from the clearinghouse 320. For example, as described above, an ESP 340A (e.g., a public safety answering point (PSAP)) can receive an emergency alert in the form of a 9-1-1 phone call 332 (representative of an emergency or potential emergency) from a mobile phone 300A associated with a phone number (e.g., (555) 555-5555). The ESP 330A can then send an emergency data request including the phone number (i.e., the identifier associated with the emergency alert) to the ERDP 310, which can then retrieve any emergency data within the clearinghouse 320 associated with the phone number and return the available emergency data to the requesting ESP 330A. This process of returning emergency data to an ESP in response to an emergency data request is referred to as “pulling” emergency data from the clearinghouse.

As described above, in some embodiments, the emergency response data platform (ERDP) can “push” emergency data from the Emergency Clearinghouse to emergency service providers (ESPs), such as by using an emergency data subscription system (hereinafter, “subscription system”). FIG. 3B depicts a flow diagram of a process for pushing emergency data from the Emergency Clearinghouse to one or more ESPs. In some embodiments, a member of an ESP (e.g., a PSAP staff member) logs into the emergency response application 360B at an ESP system 330B (e.g., a computing device associated with the ESP) by accessing the emergency response application 360B (e.g., by navigating to the emergency response application 360B through a web browser) and submitting their login information through the GUI of the emergency response application 360B. In some embodiments, when the ESP member logs into the emergency response application 360B by submitting their login information, the emergency response application 360B or ERDP 310 then determines an ESP account ID associated with the ESP member's account and establishes a persistent or active communication link (e.g., a websocket connection) with the ESP system 330B, thereby automatically subscribing the ESP console to the ESP account ID for the duration of their login session. Then, as described above, when the ERDP 310 receives an emergency alert including a location (e.g., when an emergency call is made from an communication device 300B and sends an emergency alert to the ERDP 310 including a location generated by the communication device 300B), the ERDP 310 retrieves a geofence associated with every ESP registered with the ERDP 310 and determines if the location falls within any of the geofences. In response to determining that the location falls within a geofence associated with the ESP associated with the ESP account ID, the ERDP 310 then associates the location with the ESP account ID, determines if there are any active or persistent communication links between the ERDP 310 and any computing devices subscribed to the ESP account ID. In this instance, because the ESP system 330B is subscribed to the ESP account ID and actively linked to the ERDP 310 through the persistent or active communication link, the ERDP 310 automatically pushes (e.g., from the clearinghouse) the emergency alert or emergency data associated with the emergency alert (e.g., the location, a phone number, etc.) to the ESP system 330B for display within the emergency response application 360B. In some embodiments, emergency alerts or emergency data associated with emergency alerts that have been pushed to an ESP are displayed within a jurisdictional awareness view, as described below.

For example, ESP system 330B and ESP system 330C are two different ESP consoles associated with the same ESP (e.g., two computing devices at the same public safety answering point (PSAP)), PSAP A. ESP system 330D is associated with a second ESP, PSAP B. One day, PSAP call-takers access and successfully log into the emergency response application 360 (emergency response application 360D-360D) at each of the three ESP system (ESP systems 330B-330D), thereby establishing three separate active communication links, one active communication link between the ERDP 310 and each of the three ESP consoles. The ESP consoles are automatically subscribed by the ERDP 310 to the ESP account IDs associated with their respective ESPs (ESP ID A for PSAP A and ESP ID B for PSAP B). Both PSAP A and PSAP B are associated with only one geofence, geofence A and geofence B, respectively. Geofences A and B do not overlap. The geofences have previously been tagged within the ERDP 310 with their respective ESP account IDs (e.g., during a registration process for the emergency response application).

Later that day, an emergency call is made from communication device 300B, which causes communication device 300B to generate a first emergency alert including a first location of the communication device 300B and transmit the first emergency alert to the ERDP 310. When the ERDP 310 receives the first emergency alert, the ERDP 310 retrieves some or all of the geofences stored within the ERDP 310 and determines if the first location falls within any of the geofences stored within the ERDP 310. In this example, the ERDP 310 determines that the first location falls within geofence A, associated with PSAP A. In response, the ERDP 310 tags the first location with the ESP account ID associated with geofence A, ESP ID A. The ERDP 310 then determines if there are any active communication links between the ERDP and any ESP consoles subscribed to ESP ID A and automatically pushes (e.g., from the clearinghouse) the first emergency alert to those ESP consoles. In this example, both ESP system 330B and ESP system 330C are subscribed to ESP ID A, so the ERDP 310 automatically pushes the first emergency alert to both ESP system 330B and ESP system 330C for display within emergency response applications 360B and 360C, respectively, such as through a jurisdictional awareness view (as described below). The first location does not fall within geofence B, because geofence A and geofence B do not overlap, so the first emergency alert is not pushed to ESP system 330D, even though an active communication link has been established between the ERDP 310 and ESP system 330D.

Three minutes later, the ERDP 310 receives an emergency alert from electronic device 300D (e.g., a home security system) including a second location of the electronic device 300D. When the ERDP 310 receives the second emergency alert, the ERDP again retrieves some or all of the geofences stored within the ERDP 310 and determines if the second location falls within any of the geofences stored within the ERDP 310. In this example, the ERDP 310 determines that the second location falls within geofence B, associated with PSAP B. In response, the ERDP 310 tags the second location within the ESP account associated with geofence B, ESP ID B and automatically pushes the second emergency alert to ESP system 330D for display within emergency response application 360D, because ESP system 330D has an active communication link established with the ERDP 310 and ESP system 330D is subscribed to ESP ID B. The ERDP 310 does not push the second emergency alert to ESP system 330B or ESP system 330C. Although ESP system 330B and ESP system 330C have active communication links established with the ERDP 310, they are not subscribed to ESP ID B, and geofence A and geofence B do not overlap, meaning the second location does not fall within geofence A. Two minutes after that, the ERDP 310 receives an emergency alert from electronic device 300C (e.g., an intelligent vehicle system) including a third location of the electronic device 300C. The ERDP 310 determines that the third locations falls within geofence A (like the first location included in the first emergency alert) and thus automatically pushes the third emergency alert to both ESP system 330B and ESP system 330C for display within emergency response application 360B and 360C. In some embodiments, emergency response application 360B and emergency response application 360C display the first emergency alert and the third emergency alert simultaneously, such as through a jurisdictional awareness view, as described below.

### Jurisdictional Awareness View

In some embodiments, the systems, applications, servers, devices, methods, and media of the instant application provide a jurisdictional awareness view within the emergency response application. In some embodiments, the jurisdictional awareness view enables an ESP to view one or more ongoing or recently received emergency alerts (e.g., emergency calls) within one or more geofenced jurisdictions. FIG. 2 illustrates the jurisdictional awareness view displayed within the emergency response application, in accordance with one embodiment of the present disclosure. In some embodiments, the jurisdictional awareness view includes one or more lists of incidents 210 that displays one or more incidents 212 associated with one or more device identifiers (e.g., phone numbers, IP addresses). Here, the display includes two lists-one includes all calls received by an agency and another one is for the calls received by a particular position (which is a subset of all calls queue). In some embodiments, the jurisdictional awareness view additionally or alternatively includes an interactive map 220 that displays one or more incident locations 224 associated with the one or more incidents 212 associated with the one or more device identifiers, as described below. In some embodiments, the jurisdictional awareness view displays incidents and incident locations only for emergencies occurring within the jurisdiction 222 of the ESP at which the emergency response application 260 is being accessed.

For example, in the example illustrated in FIG. 2, an ESP has accessed an emergency response application 260 provided by the ERDP. In this example, the ERDP has pushed emergency data associated with five different emergency alerts to the ESP (as described above) through the emergency response application 260. Accordingly, the emergency response application 260 displays five different incidents 212 (e.g., incidents 212A-212E) within the list of incidents 210 and five corresponding incident locations 224 (e.g., incident locations 224A-224E) within the interactive map 262. As illustrated by FIG. 2, in some embodiments, incidents 212 and incident locations 224 may be selected or hovered over to highlight a particular incident 212. In this example, incident 212C and its corresponding incident location 224C have been selected and highlighted. In some embodiments, selecting a particular incident 212 or corresponding incident location 224 prompts the emergency response application 260 to display additional information associated with the particular incident 212 (e.g., additional emergency data or information associated with the emergency alert for which the particular incident 212 was created). Because the jurisdictional awareness view can show an ESP numerous incidents 212 occurring within the jurisdiction 222 of the ESP simultaneously, the jurisdictional awareness view can provide the ESP with situational awareness that the ESP otherwise would not have. For example, with the knowledge that incidents 212A and 212B originated in close proximity and at approximately the same time, an ESP personnel (e.g., a call taker at a public safety answering point) can determine that the two incidents may be related.

### Emergency Call Data Sharing

As described above, in various embodiments, an emergency response data platform (ERDP) receives and transmits emergency data (e.g., emergency locations, such as device-based hybrid locations) from various data sources (e.g., smart devices and systems) and to various data recipients (e.g., emergency service providers). In some embodiments, as mentioned above, the ERDP is additionally capable of sourcing and receiving emergency call data (e.g., data associated with emergency calls received by ESPs, as described below) and transmitting the emergency call data to ESPs along with relevant emergency data. By receiving emergency call data in addition to emergency data, and by transmitting both emergency call data and emergency data to an ESP, the ERDP is capable of providing emergency information (e.g., locations) to an ESP for all of the emergency calls received by the ESP, whether an emergency call received by the ESP is made by a mobile phone or a landline phone.

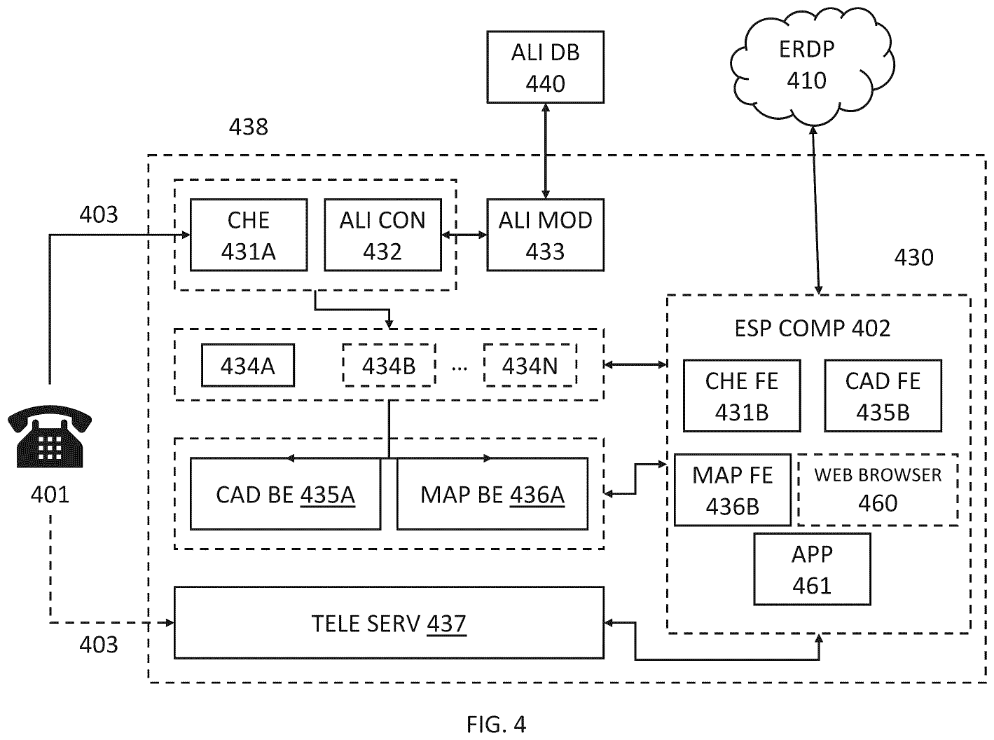

FIG. 4 depicts a diagram of an ESP in communication within an ERDP. As depicted in FIG. 4, in some embodiments, an ESP 430 includes call handling equipment (CHE) 431, an automatic location identification (ALI) controller 432, one or more ALI modems 433, one or more serial-to-ethernet converters (SECs) 434, a computer aided dispatch (CAD) system 435, a mapping system 436, a telephony server 437, and one or more ESP computing devices 402. In some embodiments, some or all of the components of an ESP are communicatively coupled by an ESP network 438 (e.g., a hardline or wireless communication network). In some embodiments, the CHE 431 is combination of hardware and software systems configured to manage the receipt and handling of emergency calls routed to an ESP 430. In some embodiments, the CHE 431 includes a hardware component 431A and a frontend component (e.g., a user interface, which may include physical and digital components, such as a headset and a graphical user interface) CHE frontend 431B, which is executed on an ESP computing device 402. In some embodiments, the CHE hardware component 431A includes a backend software application. In some embodiments, the ALI controller 432 is a hardware or software system configured to manage the querying of an ALI database 440 for emergency call data and the receipt of emergency call data from the ALI database 440. In some embodiments, the CHE 431 and the ALI controller 432 are one unified system (e.g., the CHE 431 and the ALI controller 432 are built into a single piece of hardware). In some embodiments, an ALI modem 433 is a hardware system or device (e.g., a modem) through which the querying for and receipt of emergency call data from the ALI database 440 is made. In general, an ALI database is a secure database that contains hardcoded addresses (e.g., a street address) associated with hardline phones. In some embodiments, as described below, an ESP 430 queries an ALI database 440 (e.g., the ALI controller 432 transmits a query to the ALI database 440 through an ALI modem 433) when the ESP 430 receives an emergency call, in order to obtain the emergency caller's location.

In some embodiments, a serial-to-ethernet converter (SEC) 434 (also referred to as a “port server” or “digi port server”) is a hardware system or device that allows a serial port to communicate with an ethernet port. Because ALI feed into the agency and/or CHE systems typically output data through serial ports, and because CAD, mapping, and CHE frontend software systems are typically executed on hardware devices and systems that do not have or cannot receive serial inputs, SECs 434 are typically necessary components of an ESP 430.

As described herein, a CAD system 435 is a system that facilitates and manages the dispatch of first responders, such as policemen, firemen, and emergency medical personnel. In some embodiments, a CAD system 435 includes a backend software system CAD backend 435A and a frontend software system CAD frontend 435B, which is executed on an ESP computing device 402. A mapping system 436 provides a visualization of emergency locations in relation to other landmarks or first responders through a map within a graphical user interface. In some embodiments, a mapping system 436 includes a backend software system mapping backend 436A and a frontend software system mapping frontend 436B, which is executed on an ESP computing device 402. In some embodiments, the CAD system 435 and the mapping system 436 are one unified system (e.g., the CAD system 435 and the mapping system 436 are programmed into a single software application).

In some embodiments, as depicted in FIG. 4, when an emergency call 403 is made from a hardline phone 401 and routed to an ESP 430, emergency call data, such as the audio component of the emergency call (hereinafter, “voice data”) and the phone number associated with the hardline phone, is first received by the CHE 431 (e.g., the CHE hardware component 431A). In some embodiments, the emergency call data is first received by the CHE 431 and the telephony server 437 in parallel. In some embodiments, after receiving the emergency call data, the CHE 431 then relays, forwards, or transmits the voice data to the telephony server 437, which is configured to relay the voice data to an ESP computing device 402. However, the emergency call data first received by the CHE 431 or the telephony server 437 does not include a location. To obtain a location associated with the hardline phone 401, the ALI controller 432 must then submit a query comprising the phone number associated with the hardline phone 401 to the ALI database 440, as described above. If the ALI database 440 includes a location (e.g., a hardcoded address, such as a street address) associated with the phone number (and therefore associated with the hardline phone 401), the ALI database 440 returns the location associated with the hardline phone 401 to the ALI controller 432. The CHE 431 can then relay (e.g., through an SEC 434) the emergency call data, which now includes both the phone number associated with the hardline phone 401 and the location associated with the hardline phone 401, to the CAD system 435 (e.g., the CAD backend 435A), the mapping system 436 (e.g., the mapping backend 436A), and/or the CHE frontend 431B. Once the CHE 431 has relayed the emergency call data to the CAD system 435, the mapping system 436, and/or the CHE frontend component CHE fronted 431B, a telecommunicator can use an ESP computing device 402, which includes the CHE frontend 431B, the CAD frontend 435B, and the mapping frontend 436B, to respond to the emergency call (e.g., speaking to the emergency caller to determine the nature of the emergency, and then dispatching the appropriate first responders, if necessary).

In some embodiments, as described above, the emergency response data platform (ERDP) 410 provides an emergency response application 461 that can be accessed via a web browser 460 that can be executed on an ESP computing device 402. In some embodiments, as described above, the ERDP 410 receives emergency data from smart devices and systems and then provides relevant emergency data to appropriate ESPs 430. As described above, in many cases, when an emergency call is made to an ESP 430 by a mobile phone (e.g., an emergency call is made by the mobile phone and then routed to the ESP 430), the mobile phone transmits an emergency alert including a location generated by the mobile phone (e.g., a device-based hybrid location) to the ERDP 410. The ERDP 410 can then determine which ESP 430 should receive the emergency alert and/or the location generated by the mobile device, such as by using a geofencing or subscription system (as described above), and then transmit the emergency alert and/or the location generated by the mobile phone (as well as any other emergency data that the ERDP 410 may determine relevant to or associated with the emergency or the emergency alert) to the appropriate ESP 430, such as through the emergency response application 461 accessed via the web browser 460 executed on an ESP computing device 402. However, as mentioned above, ESPs 430 receive emergency calls from both mobile phones and hardline phones. If the ERDP 410 were to transmit only emergency data to an ESP 430, the ERDP 410 would not be transmitting emergency information to the ESP 430 for all of the emergency calls received by the ESP 430, only emergency calls received by the ESP 430 from mobile phones.

### Emergency Call Data Broadcast Accessed by Emergency Response Application

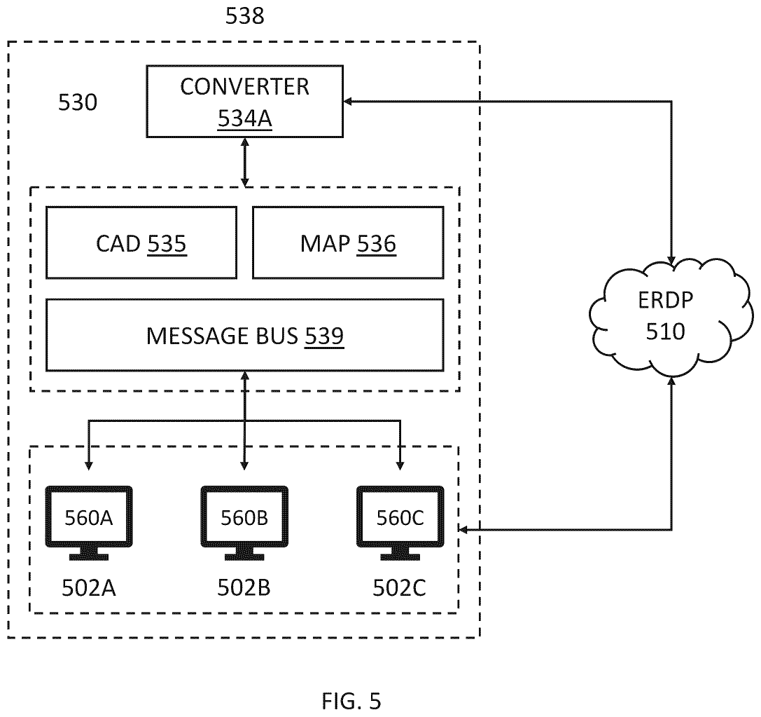

FIG. 5 depicts various systems and methods for an emergency response data platform (ERDP) to source and receive emergency call data from an emergency service provider (ESP). In some embodiments, the ERDP 510 can receive emergency call data received by an ESP 530 through an emergency response application 560 provided to the ESP 530 by the ERDP 510. For example, in some ESP implementations, after emergency call data is received by an ESP 530 and has been passed through an SEC 534 (as described above) to a CAD system 535 and a mapping system 536, the emergency call data may be relayed (e.g., by the CAD system 535) to an ESP message bus 539 that is accessible to any or all devices on the ESP network 538 (the relaying of data to a message bus will be referred to hereinafter as “broadcasting”). Then, when an ESP computing device 502 on the ESP network 538 is executing an instance of the emergency response application 560 provided by the ERDP 510, the ERDP 510 is also able to access the ESP message bus 539, through the emergency response application 560. In some implementations, the emergency response application 560 may include a browser plug-in, applet, or an executable file that is operative to monitor to the message bus 539 for emergency call data, and provide the emergency call data to the ERDP 510 through the emergency response application 560 instance executing on the same ESP computing device 502 as the browser plug-in, applet or executable file. Thus, through the emergency response application 560, when it is executed on an ESP computing device 502 on the ESP network 538, the ERDP 510 is then able to receive emergency call data that is broadcasted over the ESP network 538 message bus 539. In some embodiments, an instance of the emergency response application 560 executed on an ESP computing device 502 on the ESP network 538 transmits emergency call data that has been broadcasted to the ESP message bus 539 to the ERDP 510 as soon as the emergency call data broadcasted on the ESP message bus 539 is detected or intercepted. In other words, the emergency response application 560 instance, and/or it's associated browser plug-in, applet or executable file, performs a packet sniffer operation to detect the relevant packets being broadcast on the message bus 539. An instance of the emergency response application 560 executing on an ESP computing device 502 may therefore detect and transmit emergency call data that has been broadcasted over the ESP message bus 539 periodically (e.g., once every five seconds). As depicted in FIG. 5, multiple instances of the emergency response application 560 can be executed on multiple respective ESP computing devices 502 (e.g., emergency response application instance 560A executed on ESP computing device 502A and emergency response application instance 560B executed on ESP computing device 502B, etc.). In some embodiments, when multiple instances of the emergency response application 560 are executed on multiple respective ESP computing devices 502 on an ESP network 538, all instances of the emergency response application 560 may transmit emergency call data that has been broadcasted to the ESP message bus 539 to the ERDP 510. In some embodiments, when multiple instances of the emergency response application 560 are executed on multiple respective ESP computing devices 502 on an ESP network 538, only one instance of the emergency response application 560 may transmit emergency call data that has been broadcasted to the ESP message bus 539 to the ERDP 510. In other words, only one emergency response application 560 instance may be configured to perform the packet sniffing operation to detect packets with emergency call data broadcast on the message bus 539. In some such embodiments, if a first instance of the emergency response application 560 that i0-s transmitting emergency call data that has been broadcasted to the ESP message bus 539 to the ERDP 510 is closed, a second instance of the emergency response application 560 that is still being executed on an ESP computing device 502 on the ESP network 538 takes over the role of packet sniffing and will begin to detect and transmit emergency call data from the ESP message bus 539 to the ERDP 510, in replacement of the first instance of the emergency response application 560.

### Intelligent Converter

In some embodiments, the ERDP 510 can receive emergency call data received by an ESP 530 from an intelligent converter, e.g., a serial-to-ethernet such as SEC 534. For example, in some embodiments, a software or programming script can be added or otherwise integrated into the hardware and/or software of an SEC 534 that includes instructions configured to prompt the SEC 534 to transmit emergency call data received by an ESP 530 to the ERDP 510 when the emergency call data is passed through the SEC 534. In some embodiments, the SEC 534 duplicates the emergency call data and transmits the emergency call data to the ERDP 510. In some embodiments, the software or programming script is provided by the ERDP 510. In some embodiments, the software or programming script is integrated into the SEC 534 before the SEC 534 is installed at the ESP 530. In some embodiments, the software or programming script is provided to and integrated into the SEC 534 remotely (e.g., through an internet connection). In some embodiments, the software or programming script is integrated into the SEC 534 after the SEC 534 is installed at the ESP 530. In some embodiments, the SEC 534 includes a wireless communication component and transmits the emergency call data to the ERDP 510 through a cellular communication link. In some embodiments, the SEC 534 transmits emergency call data to the ERDP 510 as soon as the emergency call data is passed through the SEC 534. In some embodiments, the SEC 534 transmits emergency call data to the ERDP 510 periodically (e.g., once every five seconds).

### Emergency Call Data Received Through Emergency Data Request

As described above, in some embodiments, the ERDP 510 maintains a clearinghouse of emergency data (also referred to as an “Emergency Clearinghouse”) and can receive queries for emergency data from ESPs 530 via e.g., LIS App 114. In some embodiments, as described above, a query for emergency data (also referred to as an “emergency data request”) includes a user identifier (e.g., a phone number, a name, an email address, an account number, user ID) that the ERDP 510 can use to identify emergency data (such as location or additional data) received by the clearinghouse that is associated with the user identifier. The ERDP 510 can then return the emergency data associated with the user identifier to the requesting ESP 530. In some embodiments, the ERDP 510 can receive emergency call data within a query from an ESP 530. For example, in some embodiments, when an ESP 530 transmits an emergency data request to the ERDP 510, the emergency data request includes emergency call data received by the ESP 530. The ERDP 510 can then ingest and/or store the emergency call data that was included in the emergency data request. In some embodiments, the ESP 530 transmits the emergency data request to the ERDP 510 through an ESP application (e.g., a CHE backend application or a CAD system 535) after the emergency call data is received by the ESP application (as described above). In some embodiments, the ESP 530 transmits an emergency data request including emergency call data to the ERDP 510 periodically (e.g., once every five seconds).

### Emergency Data and Emergency Call Data

In some embodiments, after the ERDP has received emergency call data (e.g., through the emergency response application, from an SEC, within an emergency data request, or through any other means), the ERDP can transmit the emergency call data to an ESP (e.g., for display within an emergency response application provided to the ESP by the ERDP). In some embodiments, before transmitting the emergency call data to an ESP, the ERDP converts the emergency call data from a first format into a second format. For example, in some embodiments, such as when the ERDP receives the emergency call data from an SEC (as described above) or through an emergency response application executed on an ESP computing device on an ESP network to which the emergency call data has been broadcasted on an ESP message bus (as described above), the ERDP may receive the emergency call data as a raw or unprocessed text. In some embodiments, the ERDP then converts the emergency call data from raw or unprocessed text into formatted data that includes a plurality of data fields. In some embodiments, the ERDP converts the emergency call data from raw or unprocessed text into formatted data that is compliant with Emergency Incident Data Object (EIDO) standards. In some embodiments, the formatted data includes at least one phone number and at least one location associated with the at least one phone number. In some embodiments, such as when the ERDP receives the emergency call data within an emergency data request, the ERDP may receive the emergency call data as pre-formatted data. In some embodiments, when the emergency call data has been properly formatted (whether it was pre-formatted when it was received by the ERDP or formatted by the ERDP after it was received by the ERDP), the ERDP can then transmit the emergency call data to an ESP, as described below. In some embodiments, such as when an emergency response application executed on an ESP computing device on an ESP network accesses emergency call data that has been broadcasted to an ESP message bus, the emergency response application can format the emergency call data (if necessary) and display the emergency call data within the graphical user interface of the emergency response application (as described below) without first transmitting the emergency call data to the ERDP.

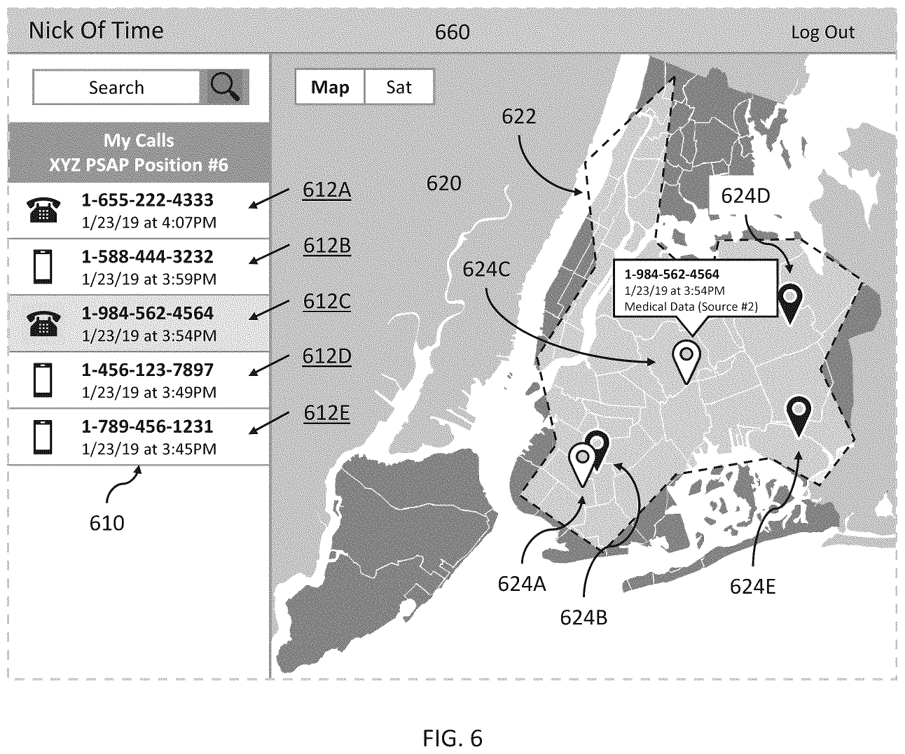

FIG. 6 illustrates an emergency response application provided by an emergency response data platform (ERDP) to an emergency service provider (ESP) in accordance with various embodiments. In some embodiments, as described above, when the ERDP receives emergency data from one or more emergency data sources (e.g., emergency data generated a mobile phone when an emergency call is made by the mobile phone), the ERDP can transmit the emergency data to an appropriate ESP for display within the graphical user interface of an emergency response application provided to the ESP by the ERDP. In some embodiments, as mentioned above, when the ERDP receives emergency call data (e.g., data associated with emergency calls made by landline phones) from an ESP, the ERDP can transmit the emergency call data to the ESP for display within the graphical user interface of an emergency response application provided to the ESP by the ERDP. In some embodiments, as illustrated in FIG. 6, the ERDP can transmit both emergency data and emergency call data to an ESP, thereby providing emergency information (e.g., emergency data or emergency call data) to the ESP for emergency calls made by both mobile phones and landline phones.

For example, emergency response application 660 is executed on an ESP computing device at XYZ PSAP on XYZ PSAP's ESP network. In this example, when an emergency call is made by a landline phone and routed to XYZ PSAP, the call handling equipment (CHE) employed by XYZ PSAP queries an ALI database (as described above) receives emergency call data associated with the emergency call, including a phone number and an address, from the ALI database, and broadcasts the emergency call data to XYZ PSAP's ESP message bus (as described above). In this example, because the emergency response application 660 is executed on the ESP computing device at XYZ PSAP, which is on XYZ PSAP's ESP network, the emergency response application 660 is able to access the emergency call data broadcasted to XYZ PSAP's ESP message bus (as described above). In this example, two emergency calls have been made by landline phones and routed to XYZ PSAP. XYZ PSAP's CHE has queried an ALI database for emergency call data associated with the two emergency calls made by the landline phones, received emergency call data associated with the two emergency calls made by landline phones from the ALI database, and broadcasted the emergency call data to XYZ PSAP's ESP message bus. The emergency response application 660, which is executed on an ESP computing device on XYZ PSAP's ESP network, has accessed XYZ PSAP's ESP message bus and transmitted the emergency call data to the ERDP. In this example, the ERDP has received the emergency call data from the emergency response application 660, converted the emergency call data from raw or unprocessed text into formatted data including at least two data fields (e.g., phone number and address), and transmitted the formatted data to the emergency response application 660 executed on the ESP computing device at XYZ PSAP. The graphical user interface (GUI) of emergency response application 660 now displays the phone numbers associated with the two emergency calls made by hardline phones as incidents 612 (e.g., incidents 612A and 612C) within a list of incidents 610 and displays the addresses associated with the two emergency calls made by landline phones as incident locations 624 (e.g., incident locations 624A and 624C, respectively) within an interactive map 620.

Additionally, in this example, the ERDP has received three emergency alerts associated with three different emergency calls made by mobile phones, each of which included a phone number associated with the mobile phone that generated the emergency alert and an emergency location that falls within the jurisdiction of XYZ PSAP (represented by geofence 622). In response, the ERDP has automatically pushed (as described above) the emergency data (e.g., the phone number and the emergency location) included in the three emergency alerts to XYZ PSAP through the emergency response application 660 executed on the ESP computing device at XYZ PSAP. The GUI of emergency response application 660 now displays the phone numbers associated with the three emergency alerts as incidents 612 (e.g., incidents 612B, 612D, and 612E) within the list of incidents 610 and displays the emergency locations associated with the three emergency alerts as incident locations 624 (e.g., incident locations 624B, 624D, and 624E, respectively) within the interactive map 620. In this way, the ERDP has been able to provide emergency information (e.g., emergency data or emergency call data) to XYZ PSAP for emergency calls made by both mobile phones and landline phones. In some embodiments, as illustrated in FIG. 6, incidents 612 associated emergency calls made by landline phones (e.g., incident 612A) display a different icon (e.g., a landline phone icon) than the icon (e.g., a mobile phone icon) displayed for incidents 612 associated with emergency calls made by mobile phones (e.g., incident 612B). In some embodiments, as illustrated in FIG. 6, incident locations 624 associated with emergency calls made by landline phones (e.g., incident location 624A) are visually distinct from incident locations 624 associated with emergency calls made by mobile phones (e.g., incident location 624B). For example, as illustrated in FIG. 6, in some embodiments, the incident locations 624 associated with emergency calls made by landline phones and the incident locations 624 associated with emergency calls made by mobile phones are different colors.

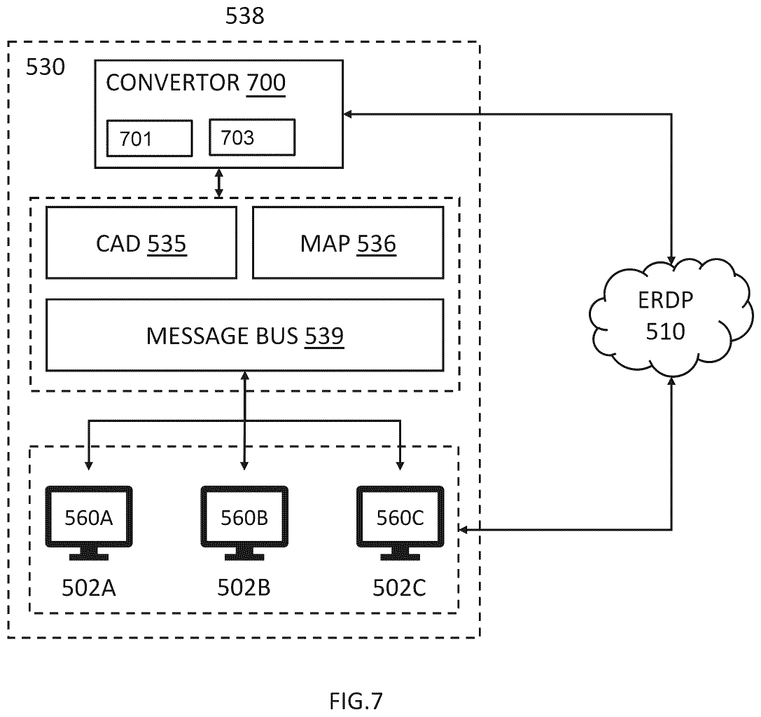

FIG. 7 is a diagram of a device 700 in accordance with some embodiments. The example device 700 includes a serial to packet converter 701 operatively coupled to a network card (not shown) and to a processor (not shown). The processor may also be operative to convert packet data from the serial to packet converter into a format such as, but not limited to, the emergency incident data object (EIDO) standard format. The device 700 may be implemented using one or more processors, ASICs, FPGAs, microcomputers, microcontrollers, digital signal processors, central processing units, and logic circuitries. The device 700 may include a non-volatile, non-transitory memory that stores software or firmware for execution on one or more processors. The device 700 may also include a packet sniffer 703 that is operative to perform a packet sniffing operation on the ESP network to detect emergency data broadcast over the ESP network to various ESP computing devices. For example, the device 700 may detect ALI data broadcast over the ESP network and intercept or copy the data packets and send the intercepted or copied data packets to the ERDP. The ERDP may then retrieve or obtain additional or updated emergency data corresponding to the ALI data broadcast packets by using device identifiers and/or other information contained in the ALI data broadcast. The packet sniffer 703 may detect emergency call data on the message bus 539 or more generally on an ESP intranet by monitoring packet traffic sent and received between various ESP computing devices operating on the ESP intranet.

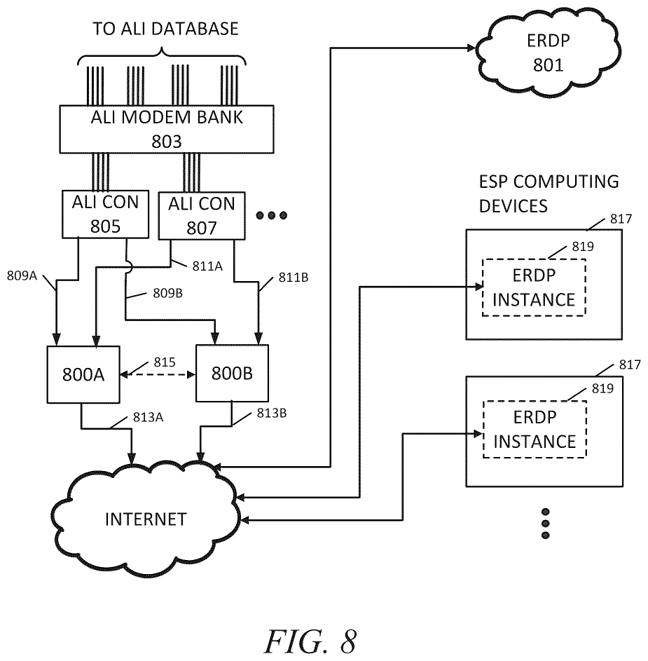

FIG. 8 is a network configuration diagram for emergency data redundancy and failure protection of, for example, an ALI data feed. In FIG. 8, and ALI modem bank 803 is operatively coupled to two or more ALI controllers such as a first ALI controller 805 and a second ALI controller 807. The ALI controllers receive ALI feed data from an ALI database via the ALI modem bank 803. The ALI feed data is a type of emergency data.

A first device 800A and a second device 800B are operatively coupled to the first ALI controller 805 and to the second ALI controller 807. The first device 800A and second device 800B are apparatuses in accordance with various embodiments herein disclosed. In one configuration, the first device 800A is operatively coupled to the first ALI controller 805 via a serial data connection 809A, and is connected to the second ALI controller 807 via a second serial data connection 811A. If either of the ALI controllers fails, the first device 800A will continue to receive serial data from the other ALI controller. The first device 800A is operative to connect to the Internet via either a wireless connection in some embodiments, or via an Ethernet port via Ethernet connection 813A. Device 800B likewise connects to the Internet via either a wireless connection in some embodiments, or via an Ethernet port via Ethernet connection 813B. Each device sends packetized ALI feed data to the ERDP 801 over the Internet.

In a second configuration, the first device 800A is operatively coupled to the first ALI controller 805 via the serial data connection 809A, and is connected to the second ALI controller 807 via the serial data connection 811A, and the second device 800B is operatively coupled to the first ALI controller 805 via the serial data connection 809B and is connected to the second ALI controller 807 via the serial data connection 811B. Therefore, both the first device 800A and the second device 800B receive two serial data feeds each, one serial data feed from each of the two ALI controllers. The devices may receive additional serial data feeds from additional ALI controllers if they are present and more than two devices such as device 800A and device 800B may also be present.

In some embodiments, a communication link 815 is present that operatively couples the first device 800A with the second device 800B. Each device is operative to send a signal over the communication link 815 indicating that it is operational. The signal may be a voltage signal, or may be implemented as a normally-open, or normally-closed contact that changes state if the device becomes inoperable and fails. In some embodiments, one device receives and sends data and a second device operates on standby and only receives data, but does not send data. If the sending device fails, an indication is received by the standby device indicating that the active sending device has failed and can no longer send or receive data. At that point, the standby device will take over and begin sending ALI feed data.

Device 800A and device 800B are identical and each device includes a serial to packet converter, and at least one Ethernet port to connect to the Internet. The devices may each include one or more processors, ASICs, FPGAs, microcomputers, microcontrollers, digital signal processors, central processing units, logic circuitries, and a network card. The devices may include a non-volatile, non-transitory memory that stores software or firmware for execution on one or more processors. In some embodiments, the device may include a radio transceiver that is operative to communicate with the ERDP 801 via a wireless link such as, but not limited to, cellular, 3G, 4G or 5G, and/or 802.11 WiFi and to establish a wireless Internet connection.

The devices are operative to convert serial emergency data, such as ALI data received from the ALI controller 805 and the ALI controller 807, and convert the serial ALI data to packetized data. Each device is operative to convert at least two serial data inputs into packetized data and to discard duplicate packets before sending the packetized data to the ERDP 801. Therefore, if one ALI controller fails, packetized data will continue to be sent using the input from the second ALI controller. Likewise, if one the devices 800 fail, the other will continue to send data. Therefore, the configuration shown in FIG. 8 provides data redundancy in case of ALI controller failure and also device 800 failure. Each device may also be operative to convert data from a first format to a second format and may provide the packetized data in the emergency incident data object (EIDO) standard format or some other format before sending the packetized data to the ERDP 801.

Each device may send packetized data to the ERDP 801. The ERDP 801 includes a web server that provides instances of an emergency response data platform (ERDP) application where each ERDP instance 819 is accessed via a web browser executing on an ESP computing device 817. The ERDP 801 web server receives packetized ALI data from both device 800A and device 800B and discards duplicate packets. The ERDP 801 web server is operative to retrieve additional or updated emergency data corresponding to the ALI data from the devices and to provide the additional or updated emergency data to the ERDP instances 819. Each ERDP instance 819 provides a graphical user interface (GUI) that may display emergency data and may provide a list of incidents and an interactive map within the GUI. Put another way, the ERDP 801 provides a software-as-a-service (SaaS) application.

Other ESPs may also have network installations similar to the example shown in FIG. 8. For example, another ESP network having either a single ALI controller or two ALI controllers may have one or two devices such as device 800A and device 800B. Each device 800 sends emergency data to the ERDP 801. Because the ERDP 801 may maintain a geofence database that defines the geographic jurisdictional boundaries for each ESP, the ERDP 801 may check the more accurate location information it receives for a given device identifier contained in the ALI emergency data. If the location information corresponding to a given device identifier shows that the caller is located in a jurisdictional area different than the one where the emergency call was received (i.e. the emergency call was routed to a given ESP but jurisdiction for the emergency response belonged to another ESP), the ERDP 801 may alert the ESP that the emergency call it received was incorrectly routed. Likewise, the ERDP 801 may alert the correct jurisdiction ESP that an emergency call for a caller located within its jurisdiction was incorrectly routed to another ESP. This capability can be useful for cooperation and coordination of emergency responses between neighboring jurisdiction ESPs.

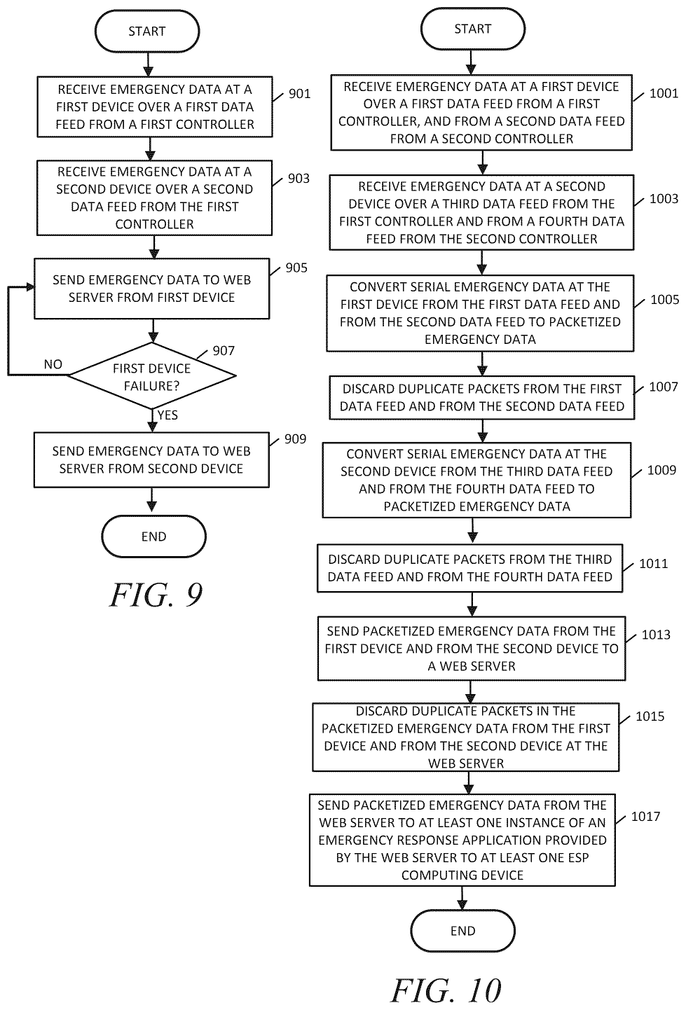

FIG. 9 is a flowchart of a method of operation in accordance with an embodiment. In operation 901 data is received at a first device, such as device 800A from a first data feed from a first controller such as ALI controller 805. In operation 903, emergency data is received at a second device, such as device 800B, from a second data feed from the first controller. In operation 905, emergency data is sent to a web server by the first device. For example, device 800A may send emergency data, which may be ALI data, to the ERDP 801 web server over the Internet. At decision 907, if the first device 800A fails, then in operation 909 the second device 800B takes over sending emergency data to the ERDP 801 web server. As long as the first device 800A remains active at decision 907, the first device 800A continues to send ALI data to the ERDP 801 web server as in operation 905, and the second device 800B remains in a hot standby mode.

FIG. 10 is a flowchart of another method of operation in accordance with another embodiment. In operation 1001 the first device 800A receives emergency data from the first ALI controller via a first data feed and from the second ALI controller via a second data feed. In operation 1003, the second device 800B receives ALI data from the first ALI controller via a third data feed and from the second ALI controller via a fourth data feed. In operation 1005 the first device 800A converts serial emergency data from the first data feed and from the second data feed to packetized emergency data. In operation 1007, the first device 800A discards duplicated packets from the first data feed and from the second data feed. In other words, packets converted from only one serial data feed may be maintained. However, in some embodiments, the packets may be compared and damaged packets may be discarded so as to reduce packet data errors that may occur during serial to packet conversion. In operation 1009 the second device 800B converts serial emergency data from the third data feed and from the fourth data feed to packetized emergency data, and discards duplicate packets in operation 1011. In operation 1013, the first device 800A and the second device 800B send the packetized emergency data to the ERDP 801 web server. In operation 1015, the ERDP web server discards duplicate packets and in operation 1017 sends the packetized emergency data to at least one ERDP instance 819 in a web browser executing on an ESP computing device 817.

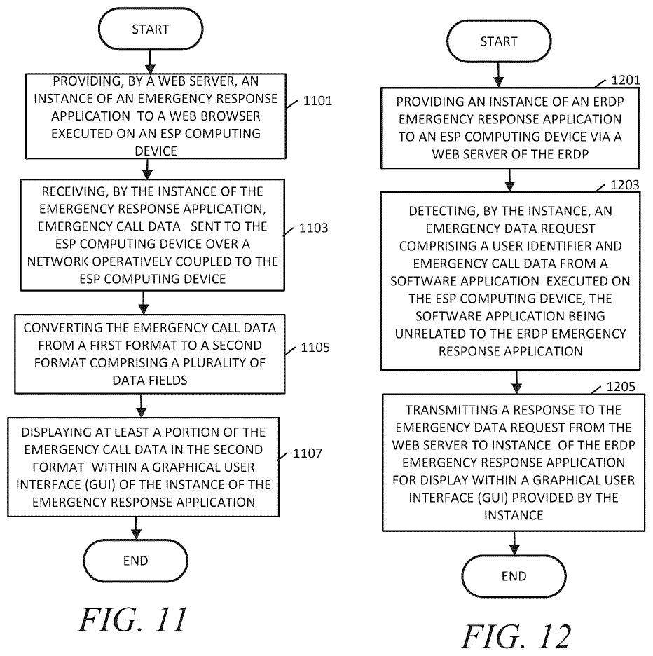

FIG. 11 is a flowchart of a method of operation in accordance with some embodiments. In operation 1101, an ERDP web server provides an instance of an emergency response application to a web browser executed on an ESP computing device. In operation 1103, the instance of the emergency response application receives emergency call data sent to the ESP computing device over a network operatively coupled to the ESP computing device. The emergency call data may be sent as a broadcast message. In operation 1105, the instance, or an applet associated with the instance, converts the emergency call data from a first format to a second format that includes a plurality of data fields and in operation 1107, displays at least a portion of the emergency call data in the second format within a graphical user interface (GUI) of the instance of the emergency response application.

FIG. 12 is a flowchart of another method of operation in accordance with some embodiments. In operation 1201, a web server provides an instance of an ERDP emergency response application to an ESP computing device via a web server of the ERDP. In operation 1203, the instance, or an applet associated with the instance, detects an emergency data request comprising a user identifier and emergency call data, sent from a software application executed on the ESP computing device that is unrelated to the ERDP emergency response application. In operation 1205, the ERDP web server transmits a response to the emergency data request to instance of the ERDP emergency response application for display within a graphical user interface (GUI) provided by the instance.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

1. A method for providing emergency data to an emergency service provider (ESP) by an emergency response data platform (ERDP), the method comprising:
providing, by a web server, an instance of an emergency response application to a web browser executed on an ESP computing device;
receiving, by the instance of the emergency response application, emergency call data sent to the ESP computing device over a network operatively coupled to the ESP computing device;
converting the emergency call data from a first format to a second format comprising a plurality of data fields;
displaying at least a portion of the emergency call data in the second format within a graphical user interface (GUI) of the instance of the emergency response application.

2. The method of claim 1, further comprising providing, by the web server, a second instance of the emergency response application to a second web browser executing on a second ESP computing device and displaying at least a portion of the emergency call data in the second format within a GUI of the second instance of the emergency response application.

3. The method of claim 1, wherein receiving, by the instance of the emergency response application, emergency call data sent to the ESP computing device over a network operatively coupled to the ESP computing device comprises:
receiving the emergency call data sent to the ESP computing device over a message bus.

4. The method of claim 1, further comprising:
receiving the emergency call data by a second instance of the emergency response application.

5. The method of claim 1, wherein converting the emergency call data from a first format to a second format comprises:
converting the emergency call data into an emergency incident data object (EIDO) where the second data format is an EIDO standard format.

6. The method of claim 1, wherein displaying at least a portion of the emergency call data in the second format comprises:
displaying a list of incidents and an interactive map.

7. The method of claim 6, further comprising:
displaying at least one phone number and at least one location associated with the at least one phone number, wherein the at least one phone number is displayed as an incident within the list of incidents and the at least one location is displayed as an incident location within the interactive map.

8. The method of claim 1, wherein receiving by the instance of the emergency response application, emergency call data sent to the ESP computing device over a network comprises:
receiving the emergency call data by intercepting an automatic location information (ALI) feed broadcast to the ESP computing device over the network.

9. An apparatus for emergency data to an emergency service provider (ESP) by an emergency response data platform (ERDP) at a web server comprising:
a serial to packet data converter;
a processor operatively coupled to the serial to packet data converter, the processor operative to:
receive a stream of serial data comprising emergency call data transmitted to the ESP;
convert the stream of serial emergency call data into packetized data having a data format comprising a plurality of data fields; and
transmit the formatted data to an instance of an emergency response application executed on an ESP computing device.

10. The apparatus of claim 9, wherein the processor is further operative to receive a software update from a web server hosting the emergency response application.

11. The apparatus of claim 9, wherein the processor is further operative to receive the software update remotely after the apparatus is installed on premise at an ESP site.

12. The apparatus of claim 9, wherein the processor is further operative to:
transmit a copy of the packetized data to the web server.

13. The apparatus of claim 12, wherein the serial to packet data converter is operative to:
connect via a serial port to an automatic location information (ALI) controller at the ESP to receive the emergency call data from an automatic location information (ALI) database.

14. The apparatus of claim 9, wherein the processor is further operative to:
format the emergency data into the data format comprising a plurality of data fields where the data format is an emergency incident data object (EIDO) standard format.

15. The apparatus of claim 9, wherein the instance of the emergency response application is operative to:
display a graphical user interface (GUI) comprising a list of incidents and an interactive map.

16. The apparatus of claim 15, wherein the instance of the emergency response application is further operative to:
display the emergency data within the GUI comprising at least one phone number and at least one location associated with the at least one phone number, with the at least one phone number displayed as an incident within the list of incidents and with the at least one location displayed as an incident location within the interactive map.

17. The apparatus of claim 9, wherein the instance of the emergency response application is provided to the ESP computing device by a web server.

18. The apparatus of claim 9, further comprising:
a radio transceiver, operatively coupled to the processor and to the serial to packet converter, the radio transceiver operative to send and receive emergency call data over a radio communication link.

19. A method for providing emergency data to an emergency service provider (ESP) by an emergency response data platform (ERDP), the method comprising:
providing, by a web server of the ERDP, a clearinghouse of the emergency data, wherein the clearinghouse comprises one or more databases hosted on a web server;
receiving, by the web server of the ERDP, an emergency data request comprising a user identifier and an ALI data from a software application executed on an ESP computing device regarding an emergency;
querying the clearinghouse for emergency data using the user identifier to find information about the emergency; and
transmitting, by the ERDP, a response to the emergency data request based on one or more results from the clearinghouse for display of emergency data within a graphical user interface (GUI) at the ESP computing device.

20. The method of claim 19, further comprising:
receiving, by the web server of the ERDP, an emergency alert comprising the user identifier and a device-based hybrid location generated by an electronic device associated with the user identifier;
transmitting the response comprising the location generated by the electronic device, in response to receiving the emergency data request, the device-based hybrid location.

21-39. (canceled)
